(19) United States
(12) Patent Application Publication
(10) Pub. No.: US 2017/0255950 A1
(43) Pub. Date: Sep. 7, 2017

(54) SYSTEMS AND METHODS FOR PROVIDING BLOCK CHAIN STATE PROOFS FOR PREDICTION MARKET RESOLUTION

(71) Applicant: FORECAST FOUNDATION OU, Tallinn (EE)

(72) Inventor: Joseph Krug, Knoxville, IL (US)

(73) Assignee: FORECAST FOUNDATION OU

(21) Appl. No.: 15/061,907

(22) Filed: Mar. 4, 2016

(51) Int. Cl. G06Q 30/02; G06N 7/00

(52) U.S. Cl. CPC G06Q 30/0202; G06N 7/005; H04L 9/32

(57) ABSTRACT

An outcome reported by a first prediction market may be determined. A state root hash from a given block in a block chain created during or after a resolution process of the first prediction market may be obtained. A proof that the value of an outcome obtained from the block chain is the same as reported by the first prediction market may be determined by: identifying a set of nodes within a cryptographic structure that forms a path from a top node to an outcome node containing a value of the outcome; and hashing the outcome node with any adjacent nodes and intervening nodes until a hash of the top node is obtained. Responsive to the hash of the top node matching the state root hash, the proof may be submitted to a second prediction market to resolve the second prediction market.

### FIELD OF THE DISCLOSURE

This disclosure relates to systems and methods for providing block chain state proofs for prediction market resolution.

### BACKGROUND

Prediction markets may be exchange-traded markets whose participants trade on the likely outcomes of events. The events may include any events ranging from the outcome of a political election, to sporting events, to minor decisions made by everyday people. Market prices for an individual prediction market may indicate what a crowd of participants in that market think the probability of an outcome of the event may be. Existing prediction market resolution systems typically require manual reporting and determination of actual prediction market outcomes. Usually, for a given prediction market, people or groups report individually observed outcomes to a central repository where a different person, group of people, or algorithm aggregates the various reported outcomes to develop a consensus, and determines the overall outcome of the given prediction market based on the consensus.

### SUMMARY

One aspect of the disclosure relates to a system for providing block chain state proofs for prediction market resolution. Advantageously, the present system may automatically obtain and aggregate individually observed and reported (e.g., resolved) prediction market outcomes related to a given prediction market and determine an overall outcome of the given prediction market based on the individual observations. In this way, the present system may reduce and/or prevent influence by a person and/or group aggregating the various reported outcomes on the overall outcome of the given prediction market. The present system may not require an aggregator to develop a consensus at all. Instead, the present system may rely on the permanent unalterable nature of data stored via a block chain to prove that the previously resolved individual prediction market outcomes are unchanged. Once the previously resolved individual prediction market outcomes are proven to be unchanged, the present system may use the proven outcomes to resolve the given prediction market.

The present system may comprise one or more hardware processors and/or other components. The one or more hardware processors may be configured by machine-readable instructions to determine an outcome reported by a first prediction market. The outcome of the first prediction market may be associated with a key and value. The key may include an event identification of the first prediction market and the value may convey the outcome. The one or more hardware processors may obtain a state root hash from a given block in a block chain created during or after a resolution process of the first prediction market. The given block may include a header. The header may include the state root hash. The state root hash may be a value corresponding to a state of the block chain at the time the given block was published on the block chain. The one or more hardware processors may determine a proof that the value of the outcome obtained from the block chain is the same as reported by the first prediction market by: identifying a set of nodes within a cryptographic structure that forms a path from a top node to an outcome node containing the value of the outcome; hashing the outcome node with any adjacent nodes to obtain a hash of a parent node of the outcome node; and/or successively repeating the hashing step with the parent node and any other intervening nodes between the outcome node and the top node until a hash of the top node is obtained. The one or more hardware processors may, responsive to the hash of the top node from the proof matching the state root hash, submit the proof to a second prediction market to resolve the second prediction market with respect to the outcome.

Another aspect of the disclosure relates to a method for providing block chain state proofs for prediction market resolution. The method for providing block chain state proofs for prediction market resolution may comprise determining an outcome reported by a first prediction market. The outcome of the first prediction market may be associated with a key and value. The key may include an event identification of the first prediction market and the value may convey the outcome. A state root hash may be obtained from a given block in a block chain created during or after a resolution process of the first prediction market. The given block may include a header. The header may include the state root hash. The state root hash may be a value corresponding to a state of the block chain at the time the given block was published on the block chain. A proof that the value of the outcome obtained from the block chain is the same as reported by the first prediction market may be determined by: identifying a set of nodes within a cryptographic structure that forms a path from a top node to an outcome node containing the value of the outcome; hashing the outcome node with any adjacent nodes to obtain a hash of a parent node of the outcome node; and successively repeating the hashing step with the parent node and any other intervening nodes between the outcome node and the top node until a hash of the top node is obtained. Responsive to the hash of the top node from the proof matching the state root hash, the proof may be submitted to a second prediction market to resolve the second prediction market with respect to the outcome.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for providing block chain state proofs for prediction market resolution, in accordance with one or more implementations.

FIG. 2 illustrates a cryptographic structure, in accordance with one or more implementations.

FIG. 3 illustrates a method for providing block chain state proofs for prediction market resolution, in accordance with one or more implementations.

### DETAILED DESCRIPTION

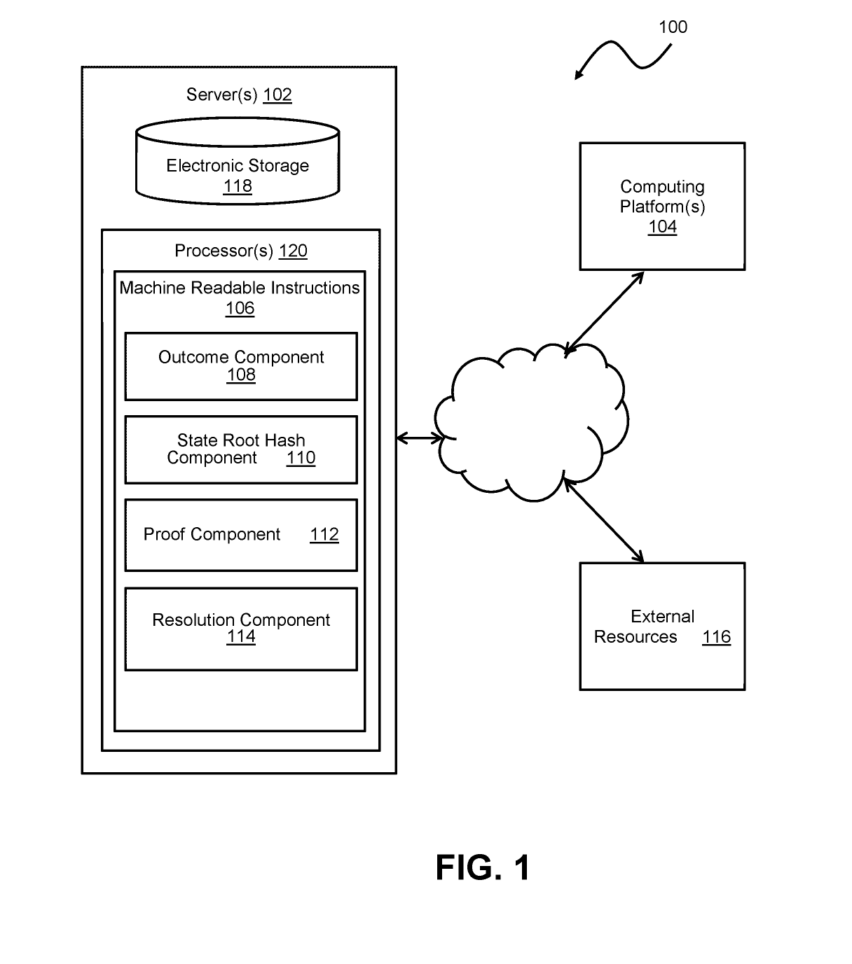

FIG. 1 illustrates a system 100 for providing block chain state proofs for prediction market resolution, in accordance with one or more implementations. In some implementations, system 100 may include one or more servers 102. The server(s) 102 may be configured to communicate with one or more computing platforms 104 according to a client/server architecture, a peer-to-peer architecture, and/or other architectures. Users may access system 100 via computing platform(s) 104.

The server(s) 102 may be configured to execute machine-readable instructions 106. The machine-readable instructions 106 may include one or more of an outcome component 108, a state root hash component 110, a proof component 112, a resolution component 114, and/or other machine-readable instruction components.

The machine-readable instructions 106 may be executable to use a block chain to provide state proofs for prediction market resolution. Generally speaking, a block chain is a transaction database shared by some or all nodes participating in system 100. Such participation may be based on the Ethereum protocol, Bitcoin protocol, Rootstock protocol, and/or other protocols related to block chains. A full copy of the block chain contains every transaction ever executed associated with the block chain. In addition to transactions, other information may be contained by the block chain, such as described further herein.

The block chain may be based on several blocks. A block may include a record that contains and confirms one or more waiting transactions. Periodically (e.g., roughly every 15 seconds), a new block including transactions and/or other information may be appended to the block chain. In some implementations, a given block in the block chain contains a hash of the previous block. This may have the effect of creating a chain of blocks from a genesis block (i.e., the first block in the block chain) to a current block. The given block may be guaranteed to come chronologically after a previous block because the previous block's hash would otherwise not be known. The given block may be computationally impractical to modify once it is included in the block chain because every block after it would also have to be regenerated.

Outcome component 108 may be configured to determine an outcome of a (e.g., first) prediction market. The outcome, and/or information indicating the outcome, may be stored in a block of the block chain. In some implementations, the block chain may be the Ethereum block chain and/or other block chains. In some implementations, determining an outcome of a prediction market may include obtaining the information indicating the outcome from the block of the block chain where the information is stored. The outcome of the (first) prediction market may be associated with a key and value (e.g., a key/value pair), and/or other information. The key may include an event identification of the (first) prediction market and/or other information. The value may convey the outcome of the prediction market and/or other information. In some implementations, the key and value may be referenced in a database (e.g., an Ethereum database) associated with the block chain. In some implementations, the key and value may be referenced in such a database by their hash which is used by outcome component 108 to look up the key and value in the block chain and determine the outcome of the (first) prediction market.

State root hash component 110 may be configured to obtain a state root hash of any block in the block chain created during or after a resolution process of the (first) prediction market. A given block may include a header and/or other components. The header may include the state root hash and/or other information. In some implementations, the state root hash may be a value corresponding to a state of the block chain at the time the given block was published on the block chain. The state root hash may be an identifier unidirectionally and/or uniquely related to a given data set stored via the block chain. The state root hash may be representative of any number of data units (e.g., the value outcome of the first prediction market included) in a hashed cryptographic data structure. In some implementations, the state root hash may indicate a relative position of data units from a hashed cryptographic data structure relative to each other. For example, the state root hash may indicate a position of a value of the outcome of the (first) prediction market relative to other data units stored in a cryptographic structure via the block chain.

Proof component 112 may be configured to determine a proof that the value of an outcome of the (first) prediction market obtained from the state root hash of the block in the block chain is the same as reported by the (first) prediction market. Determining a proof may include identifying a set of nodes within a cryptographic structure that form a path from a top node to an outcome node. In some implementations, the cryptographic structure may include a Merkle-Patricia tree and/or other cryptographic structures. A Merkle-Patricia tree is a cryptographically verifiable data structure used to store keys and values. Each key corresponds to one value in the tree. The key which stores a value encodes the path taken down the tree. So if a key were “A04” the path down the tree would be the A^{th} item, then the 0^{th} item, and finally the value would be located under the 4^{th} item. Patricia trees are deterministic, so any Patricia tree with the same key-value pairs will have the same root hash as any other Patricia tree. In some implementations, nodes within the Merkle-Patricia tree may comprise an empty node, a key/value pair, a branch node, and/or other nodes.

In some implementations, a key/value pair node of the Merkle-Patricia tree may be configured such that the value associated with the outcome of the (first) prediction market is indicated by the key/value pair. In some implementations, the value in the key value pair may be one of an actual value conveying the outcome, a hash of another node in the Merkle-Patricia tree, and/or other values. In some implementations, the key associated with the outcome of the (first) prediction market may be indicated by the key/value pair as the path through the cryptographic structure from the top node to the outcome node. In some implementations, the outcome node in the set of nodes that form the path from the top node to the outcome node may comprise a key/value pair.

In some implementations, a branch node may comprise a list with 17 entries, wherein the first 16 entries may be hex letters indicating various nodes and the 17^{th} entry may be a value (if there is one). A branch node may be included in a Merkle-Patricia tree responsive to two or more keys sharing a similar hex letter prefix with the final hex letters being different. Branch nodes, like any other nodes, may be stored with values as the hash of a child node and/or an actual value if the node is a terminating node at the bottom of the tree, and the key is the common prefix. Additionally, branch nodes may include one or more branch nodes within themselves when more space is needed in the Merkle-Patricia tree.

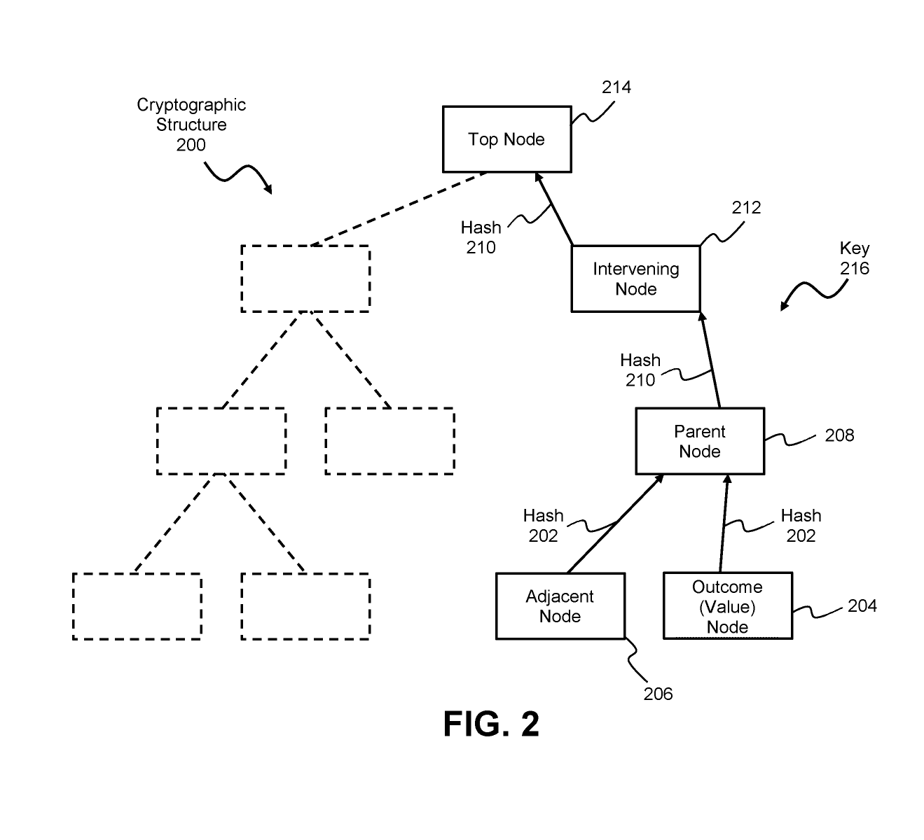

Proof component 112 may be configured such that determining a proof includes hashing the outcome node with any adjacent nodes to obtain a hash of a parent node of the outcome node. The hashing may be repeated by proof component 112 with the parent node and any intervening nodes of the cryptographic structure until a hash of the top node is obtained. For example, FIG. 2 illustrates a cryptographic structure 200, in accordance with one or more implementations. FIG. 2 illustrates hashing 202 an outcome node 204 with an adjacent node 206 to obtain a hash of a parent node 208 of outcome node 204. The hashing may be repeated 210 by proof component 112 (not shown in FIG. 2) with parent node 208 and any intervening nodes 212 of cryptographic structure 200 until a hash of a top node 214 is obtained. FIG. 2 also illustrates key 216 indicating the path (solid lines) through cryptographic structure 200 from top node 214 to outcome node 204.

Returning to FIG. 1, resolution component 114 may be configured to determine whether the hash of the top node from the proof matches the state root hash and/or other information. Resolution component 114 may submit the proof to another (e.g., a second) prediction market to resolve the other (e.g., second) prediction market with respect to the outcome of the original (e.g., first) prediction market. The proof may be submitted responsive to the hash of the top node from the proof matching the state root hash. In some implementations, responsive to the hash of the top node from the proof not matching the state root hash, the proof may be determined to be invalid. This may indicate the cryptographic structure did not in fact store the outcome reported by the original (first) prediction market, the reported outcome had been altered in some way, and/or other information. Responsive to the hash of the top node from the proof not matching the state root hash, the proof may not be submitted to the other (e.g., the second) prediction market.

In some implementations, outcome component 108, state root hash component 110, proof component 112, and/or resolution component 114 may be configured to determine a plurality of proofs for outcomes reported by a plurality of prediction markets (e.g., according to the operations described above) in addition to the outcome reported by the original (e.g., first) prediction market. Responsive to hashes of top nodes from the plurality of proofs matching corresponding state root hashes for the plurality of proofs, the plurality of proofs may be submitted to the other (e.g., the second) prediction market to resolve that prediction market with respect to the outcomes reported by the plurality of prediction markets.

In some implementations, server(s) 102, computing platform(s) 104, and/or external resources 116 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, computing platform(s) 104, and/or external resources 116 may be operatively linked via some other communication media.

A given computing platform 104 may include one or more processors configured to execute machine-readable instructions. The machine-readable instructions may be configured to enable an expert or user associated with the given computing platform 104 to interface with system 100 and/or external resources 116, and/or provide other functionality attributed herein to computing platform(s) 104. By way of non-limiting example, the given computing platform 104 may include one or more of a desktop computer, a laptop computer, a handheld computer, a tablet computing platform, a NetBook, a Smartphone, a gaming console, and/or other computing platforms.

External resources 116 may include sources of information, hosts and/or providers of block chain environments outside of system 100, external entities participating with system 100, and/or other resources. In some implementations, some or all of the functionality attributed herein to external resources 116 may be provided by resources included in system 100.

Server(s) 102 may include electronic storage 118, one or more processors 120, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 118 may comprise non-transitory storage media that electronically stores information. The electronic storage media of electronic storage 118 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 118 may include one or more virtual storage resources (e.g., cloud storage, a virtual private network, and/or other virtual storage resources). Electronic storage 118 may store software algorithms, information determined by processor(s) 120, information received from server(s) 102, information received from computing platform(s) 104, and/or other information that enables server(s) 102 to function as described herein.

Processor(s) 120 may be configured to provide information processing capabilities in server(s) 102. As such, processor(s) 120 may include one or more of a digital processor, an analog processor, a digital circuit designed to process information, an analog circuit designed to process information, a state machine, and/or other mechanisms for electronically processing information. Although processor(s) 120 is shown in FIG. 1 as a single entity, this is for illustrative purposes only. In some implementations, processor(s) 120 may include a plurality of processing units. These processing units may be physically located within the same device, or processor(s) 120 may represent processing functionality of a plurality of devices operating in coordination. The processor(s) 120 may be configured to execute machine-readable instruction components 108, 110, 112, 114, and/or other machine-readable instruction components. Processor(s) 120 may be configured to execute machine-readable instruction components 108, 110, 112, 114, and/or other machine-readable instruction components by software; hardware; firmware; some combination of software, hardware, and/or firmware; and/or other mechanisms for configuring processing capabilities on processor(s) 120. As used herein, the term “machine-readable instruction component” may refer to any component or set of components that perform the functionality attributed to the machine-readable instruction component. This may include one or more physical processors during execution of processor readable instructions, the processor readable instructions, circuitry, hardware, storage media, or any other components.

It should be appreciated that although machine-readable instruction components 108, 110, 112, and 114 are illustrated in FIG. 1 as being implemented within a single processing unit, in implementations in which processor(s) 120 includes multiple processing units, one or more of machine-readable instruction components 108, 110, 112, and/or 114 may be implemented remotely from the other machine-readable instruction components. The description of the functionality provided by the different machine-readable instruction components 108, 110, 112, and/or 114 described herein is for illustrative purposes, and is not intended to be limiting, as any of machine-readable instruction components 108, 110, 112, and/or 114 may provide more or less functionality than is described. For example, one or more of machine-readable instruction components 108, 110, 112, and/or 114 may be eliminated, and some or all of its functionality may be provided by other ones of machine-readable instruction components 108, 110, 112, and/or 114. As another example, processor(s) 120 may be configured to execute one or more additional machine-readable instruction components that may perform some or all of the functionality attributed below to one of machine-readable instruction components 108, 110, 112, and/or 114.

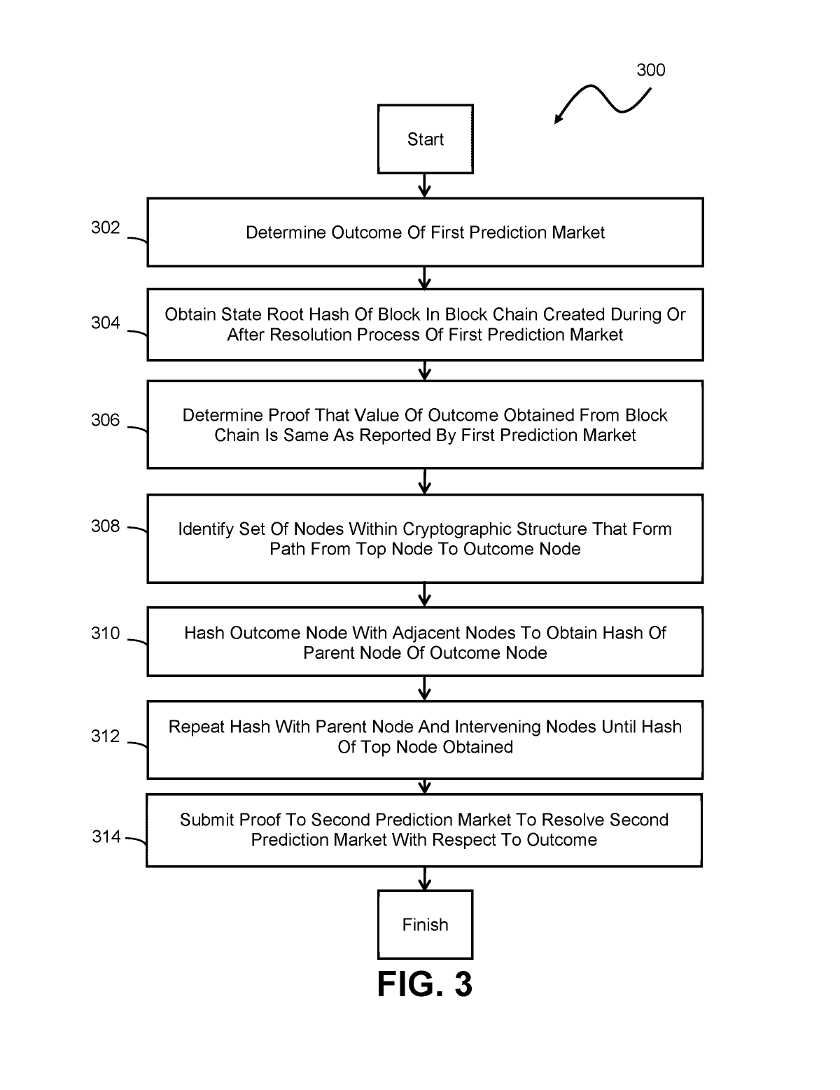

FIG. 3 illustrates a method for providing block chain state proofs for prediction market resolution, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, one or more operations of method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At an operation 302, an outcome of a first prediction market may be determined. The outcome of the first prediction market may be associated with a key and value and/or other information. The key may include an event identification of the first prediction market. The value may convey the outcome of the first prediction market. Operation 302 may be performed by one or more hardware processors configured to execute a machine-readable instruction component that is the same as or similar to outcome component 108 (as described in connection with FIG. 1), in accordance with one or more implementations.

At an operation 304, a state root hash of a given block in a block chain created during or after a resolution process of the first prediction market may be obtained. In some implementations, the block chain may be the Ethereum block chain and/or other block chains. The given block may include a header. The header may include the state root hash. The state root hash may be a value corresponding to a state of the block chain at the time the given block was published on the block chain. Operation 304 may be performed by one or more hardware processors configured to execute a machine-readable instruction component that is the same as or similar to state root hash component 110 (as described in connection with FIG. 1), in accordance with one or more implementations.

At an operation 306, a proof that a value of the outcome obtained from the block chain is the same as reported by the first prediction market may be determined. Operation 306 may be performed by one or more hardware processors configured to execute a machine-readable instruction component that is the same as or similar to proof component 112 (as described in connection with FIG. 1), in accordance with one or more implementations. In some implementations, determining the proof may include operations 308, 310, and/or 312 described below, and/or other operations.

At an operation 308, a set of nodes within a cryptographic structure that form a path from a top node to an outcome node may be identified. In some implementations, the cryptographic structure may include a Merkle-Patricia tree and/or other cryptographic structures. In some implementations, nodes within the Merkle-Patricia tree may comprise an empty node, a key/value pair, a branch node, and/or other nodes. In some implementations, a key/value pair node of the Merkle-Patricia tree may be configured such that the value associated with the outcome of the first prediction market is indicated by the key/value pair. In some implementations, the value in the key value pair may be one of an actual value conveying the outcome, a hash of another node in the Merkle-Patricia tree, and/or other values. In some implementations, the key associated with the outcome of the first prediction market may be indicated by the key/value pair as the path through the cryptographic structure from the top node to the outcome node. In some implementations, the outcome node in the set of nodes that form the path from the top node to the outcome node indicates a key/value pair. Operation 308 may be performed by one or more hardware processors configured to execute a machine-readable instruction component that is the same as or similar to proof component 112 (as described in connection with FIG. 1), in accordance with one or more implementations.

At an operation 310, the outcome node may be hashed with adjacent nodes to obtain a hash of a parent node of the outcome node. Operation 310 may be performed by one or more hardware processors configured to execute a machine-readable instruction component that is the same as or similar to proof component 112 (as described in connection with FIG. 1), in accordance with one or more implementations.

At an operation 312, the hashing may be repeated with the parent node and any intervening nodes until a hash of the top node is obtained. Operation 312 may be performed by one or more hardware processors configured to execute a machine-readable instruction component that is the same as or similar to proof component 112 (as described in connection with FIG. 1), in accordance with one or more implementations.

At an operation 314, the proof may be submitted to a second prediction market to resolve the second prediction market with respect to the outcome. The proof may be submitted responsive to the hash of the top node from the proof matching the state root hash. In some implementations, responsive to the hash of the top node from the proof not matching the state root hash, the proof may be determined to be invalid. This may indicate the cryptographic structure did not in fact store the outcome reported by the first prediction market. Operation 314 may be performed by one or more hardware processors configured to execute a machine-readable instruction component that is the same as or similar to resolution component 114 (as described in connection with FIG. 1), in accordance with one or more implementations.

In some implementations, method 300 may include determining a plurality of proofs for outcomes reported by a plurality of prediction markets (according to the operations described above) in addition to the outcome reported by the first prediction market, for example. Responsive to hashes of top nodes from the plurality of proofs matching corresponding state root hashes for the plurality of proofs, the plurality of proofs may be submitted to the second prediction market to resolve the second prediction market with respect to the outcomes reported by the plurality of prediction markets.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system, comprising:
one or more hardware processors configured by machine-readable instructions to:
determine an outcome reported by a first prediction market, the outcome of the first prediction market being associated with a key and value, the key including an event identification of the first prediction market and the value conveying the outcome;
obtain a state root hash from a given block in a block chain created during or after a resolution process of the first prediction market, the given block including a header, the header including the state root hash, the state root hash being a value corresponding to a state of the block chain at a time the given block was published on the block chain;
determine a proof that the value of the outcome obtained from the block chain corresponds to that reported by the first prediction market by:
identifying a set of nodes within a cryptographic structure that forms a path from a top node to an outcome node containing the value of the outcome;
hashing the outcome node with a sibling node to obtain a hash of a parent node of the outcome node; and
successively repeating the hashing with the parent node and any other intervening nodes between the outcome node and the top node until a hash of the top node is obtained; and
responsive to the hash of the top node from the proof matching the state root hash, submit the proof to a second prediction market to resolve the second prediction market with respect to the outcome.

2. The system of claim 1, wherein the block chain is an Ethereum block chain.

3. The system of claim 1, wherein the cryptographic structure includes a Merkle-Patricia tree.

4. The system of claim 3, wherein nodes within the Merkle-Patricia tree comprise one or more of an empty node, a key/value pair, or a branch node.

5. The system of claim 4, wherein a node of the Merkle-Patricia tree comprises the key/value pair, and wherein the value associated with the outcome of the first prediction market is indicated by the key/value pair.

6. The system of claim 5, wherein the value is one of an actual value conveying the outcome or a hash of another node in the Merkle-Patricia tree.

7. The system of claim 1, wherein the outcome node in the set of nodes that form the path from the top node to the outcome node indicates a key/value pair.

8. The system of claim 7, wherein the key associated with the outcome of the first prediction market is indicated by the key/value pair.

9. The system of claim 8, wherein the key associated with the outcome of the first prediction market is indicated by the key/value pair as the path through the cryptographic structure from the top node to the outcome node.

10. The system of claim 1, wherein the one or more hardware processors are further configured, responsive to the hash of the top node from the proof not matching the state root hash, to determine the proof is invalid and the cryptographic structure did not store the outcome reported by the first prediction market.

11. The system of claim 1, wherein the one or more hardware processors are further configured to determine a plurality of proofs for outcomes reported by a plurality of prediction markets in addition to the outcome reported by the first prediction market and, responsive to hashes of top nodes from the plurality of proofs matching corresponding state root hashes for the plurality of proofs, submit the plurality of proofs to the second prediction market to resolve the second prediction market with respect to the outcomes reported by the plurality of prediction markets.

12. A method comprising:
determining an outcome reported by a first prediction market, the outcome of the first prediction market being associated with a key and value, the key including an event identification of the first prediction market and the value conveying the outcome;
obtaining a state root hash from a given block in a block chain created during or after a resolution process of the first prediction market, the given block including a header, the header including the state root hash, the state root hash being a value corresponding to a state of the block chain at a time the given block was published on the block chain;
determining a proof that the value of the outcome obtained from the block chain corresponds to that as reported by the first prediction market by:
identifying a set of nodes within a cryptographic structure that forms a path from a top node to an outcome node containing the value of the outcome;
hashing the outcome node with a sibling node to obtain a hash of a parent node of the outcome node; and
successively repeating the hashing with the parent node and any other intervening nodes between the outcome node and the top node until a hash of the top node is obtained; and
responsive to the hash of the top node from the proof matching the state root hash, submitting the proof to a second prediction market to resolve the second prediction market with respect to the outcome.

13. The method of claim 12, wherein the block chain is an Ethereum block chain.

14. The method of claim 12, wherein the cryptographic structure includes a Merkle-Patricia tree.

15. The method of claim 14, wherein nodes within the Merkle-Patricia tree comprise one or more of an empty node, a key/value pair, or a branch node.

16. The method of claim 15, wherein a node of the Merkle-Patricia tree comprises the key/value pair, and wherein the value associated with the outcome of the first prediction market is indicated by the key/value pair.

17. The method of claim 16, wherein the value is one of an actual value conveying the outcome or a hash of another node in the Merkle-Patricia tree.

18. The method of claim 12, wherein the outcome node in the set of nodes that form the path from the top node to the outcome node indicates a key/value pair.

19. The method of claim 18, wherein the key associated with the outcome of the first prediction market is indicated by the key/value pair.

20. The method of claim 19, wherein the key associated with the outcome of the first prediction market is indicated by the key/value pair as the path through the cryptographic structure from the top node to the outcome node.

21. The method of claim 12, further comprising determining, responsive to the hash of the top node from the proof not matching the state root hash, the proof is invalid and the cryptographic structure did not store the outcome reported by the first prediction market.

22. The method of claim 12, further comprising determining a plurality of proofs for outcomes reported by a plurality of prediction markets in addition to the outcome reported by the first prediction market and, responsive to hashes of top nodes from the plurality of proofs matching corresponding state root hashes for the plurality of proofs, submitting the plurality of proofs to the second prediction market to resolve the second prediction market with respect to the outcomes reported by the plurality of prediction markets.
